(19) United States
(12) Patent Application Publication
(10) Pub. No.: US 2018/0175358 A1
(43) Pub. Date: Jun. 21, 2018

(54) BATTERY CONNECTION MODULE AND BATTERY DEVICE

(71) Applicant: Molex, LLC, Lisle, IL (US)

(72) Inventors: Yong Lin, Taipei (TW); Shang Xiu Zeng, ChengDu (CN); Kian Heng Lim, Singapore (SG)

(73) Assignee: Molex, LLC, Lisle, IL (US)

(21) Appl. No.: 15/816,634

(22) Filed: Nov. 17, 2017

(30) Foreign Application Priority Data
Dec. 19, 2016 (CN) 201611176949.2

(51) Int. Cl. H01M 2/20; H01M 2/10; H01M 2/36

(52) U.S. Cl. CPC H01M 2/202; H01M 2/365; H01M 2/1016

(57) ABSTRACT

A battery connection module and a battery device are provided, the battery device comprises a battery box and a battery connection module The battery connection module comprises a covering unit and a circuit unit The covering unit comprises a cover plate and a plurality of sealing members The cover plate has a plate body and a plurality of plugging bodies The sealing members are respectively provided to peripheries of the plugging bodies The circuit unit comprises a circuit board provided to an upper surface of the plate body, a plurality of busbars embedded in the cover plate and a plurality of conductive connecting tabs respectively connecting the busbars to the circuit board. Each busbar has a main body portion and at least two electrode connecting portions The busbars are embedded in the plate body as two rows spaced apart from each other A position of each plugging body covers two electrode connecting portion which belong to the two rows of the busbars The cover plate further has a plurality of first openings formed on the upper surface of the plate body to expose a portion of each main body portion and a plurality of second openings respectively formed on the plugging bodies to expose each electrode connecting portion.

### RELATED APPLICATIONS

This application claims priority to Chinese Application No. 201611176949.2, filed Dec. 19, 2016, which is incorporated herein by reference in its entirety.

### TECHNICAL FIELD

The present disclosure relates to a battery connection module, particularly relates to for a battery connection module for electrically connecting with and sealing a plurality of liquid battery cells and a battery device.

### BACKGROUND ART

At present, generally known battery device composed by a plurality of battery cells, in which most of the battery cells use a solid battery block, such as disclosed in US 2014/0127551A1 and US 2014/0356668 A1.

Because a structure of the solid battery block and a structure of a liquid battery cell has a great difference, when a battery device assembled by a plurality of solid battery blocks and a battery device assembled by a plurality of liquid battery cells are compared, the two battery devices are different in the whole assembling structure and electrode connecting structure design. However, most of the previous disclosed patent documents are used for assembling technique with respect to the solid battery block, so there is still a developed space for how to make assembling of the liquid battery cells more convenient and sealing effect better.

### SUMMARY

Therefore, one object of the present disclosure is to provide a battery connection module for sealing a plurality of liquid battery cells and making electrodes of the plurality of battery cells connected in series.

Therefore, another object of the present disclosure is to provide a battery device which has a plurality of liquid battery cells and has good sealing.

Accordingly, in some embodiments, a battery connection module of the present disclosure comprises a covering unit and a circuit unit. The covering unit comprises a cover plate and a plurality of sealing members. The cover plate has a plate body extending along a first direction and a plurality of plugging bodies arranged along the first direction, the plate body has an upper surface and a lower surface opposite to the upper surface, the plurality of plugging bodies integrally protrude from the lower surface of the plate body, and each plugging body extends along a second direction perpendicular to the first direction and exhibits as an elongated shape, the plurality of sealing members are respectively provided to peripheries of the plurality of plugging bodies. The circuit unit comprises a circuit board provided to the upper surface of the plate body, a plurality of busbars embedded in the cover plate and a plurality of conductive connecting tabs respectively corresponding to the plurality of busbars to connect the plurality of busbars to the circuit board. Each busbar has a main body portion and at least two electrode connecting portions, the plurality of busbars are embedded in the plate body as two rows spaced apart from each other, and each row is arranged along the first direction, positions of the electrode connecting portions of each row respectively correspond to the plurality of plugging bodies, so that a position of each plugging body covers two electrode connecting portions which are positioned in the second direction and respectively belong to the two rows of the busbars. The cover plate further has a plurality of first openings and a plurality of second openings, the plurality of first openings are formed on the upper surface of the plate body and respectively correspond to the main body portions of the plurality of busbars to expose a portion of each main body portion, the plurality of second openings are respectively formed on the plurality of plugging bodies and respectively corresponding to the electrode connecting portions of the plurality of busbars in position to expose each electrode connecting portion, and the plurality of first openings are not communicated with the plurality of second openings. Each conductive connecting tab is connected with the main body portion via the first opening so as to connect the circuit board to the main body portion.

In some embodiments, each sealing member is provided in form of gasket and is sheathed on the periphery of the plugging body.

In some embodiments, the circuit board is a flexible circuit board.

In some embodiments, each electrode connecting portion of each busbar protrudes into the second opening from the main body portion and exhibits as a protruding block.

In some embodiments, one end of each conductive connecting tab is welded to the circuit board and the other end is welded to the main body portion of the busbar via the first opening.

In some embodiments, the cover plate further has a plurality of liquid injecting holes respectively passing through the plurality of plugging bodies and the plate body.

Accordingly, in some embodiments, a battery device of the present disclosure battery device comprises a battery box and a battery connection module. The battery box has a box body and a plurality of battery cells, the box body has a plurality of spacing walls which are arranged along a first direction and spaced apart from each other to define a plurality of chambers, and the plurality of battery cells are respectively provided to the plurality of chambers, each battery cell comprises a battery liquid and electrodes. The battery connection module comprises a covering unit and a circuit unit. The covering unit covers on a top of the box body and comprises a cover plate and a plurality of sealing members. The cover plate has a plate body extending along the first direction and a plurality of plugging bodies arranged along the first direction, the plate body has an upper surface and a lower surface opposite to the upper surface, the plurality of plugging bodies integrally protrude from the lower surface of the plate body to respectively plug in the plurality of chambers, and each plugging body extends along a second direction perpendicular to the first direction and exhibits as an elongated shape, the plurality of sealing members are respectively provided to between the plurality of plugging bodies and the box body to liquid-tight seal a gap between each plugging body and the box body. The circuit unit comprises a circuit board provided to the upper surface of the plate body, a plurality of busbars embedded in the cover plate and a plurality of conductive connecting tabs respectively corresponding to the plurality of busbars to connect the plurality of busbars to the circuit board, each busbar has a main body portion and at least two electrode connecting portions, the plurality of busbars are embedded in the plate body as two rows spaced apart from each other, and each row is arranged along the first direction, positions of the electrode connecting portions of each row respectively corresponding to the plurality of plugging bodies, so that a position of each plugging body covers the two electrode connecting portions which are positioned in the second direction and respectively belong to the two rows of the busbar. The cover plate further has a plurality of first openings and a plurality of second openings, the plurality of first openings are formed on the upper surface of the plate body and respectively correspond to the main body portions of the plurality of busbars to expose a portion of each main body portion, the plurality of second openings are respectively formed on the plurality of plugging bodies and respectively correspond to the electrode connecting portions of the plurality of busbars to expose each electrode connecting portion, so that the plurality of electrode connecting portions respectively connect the electrodes in different chambers, so as to make the electrodes in the plurality of chambers connected in series, and the plurality of first openings are not communicated with the plurality of second openings. Each conductive connecting tab connects with the main body portion via the first opening to connect the circuit board to the main body portion.

In some embodiments, each sealing member is provided in form of gasket and is sheathed on a periphery of the plugging body.

In some embodiments, the circuit board is a flexible circuit board.

In some embodiments, each electrode connecting portion of each busbar protrudes from the main body portion to the second opening and exhibits as a protruding block.

In some embodiments, one end of each conductive connecting tab is welded to the circuit board and the other end is welded to the main body portion of the busbar via the first opening.

In some embodiments, the cover plate further has a plurality of liquid injecting holes respectively passing through the plurality of plugging bodies and the plate body to respectively communicate with the plurality of chambers.

In some embodiments, the lower surface of the plate body is sealed and engaged to a top surface of the box body.

In some embodiments, the lower surface of the plate body is sealed and engaged to the top surface of the box body by hot melting.

The present disclosure at least has the following effect: the battery connection module can be assembled as a module in advance, the assembling process of the battery connection module and the battery box is simpler, more convenient and easily operated, and can be indeed seal the battery liquid, and can make the plurality of electrodes in the battery box to electrically connected.

### BRIEF DESCRIPTION OF THE DRAWINGS

Other features and effects of the present disclosure will be apparent through embodiments in combination with accompanying figures in which:

FIG. 1 is a perspective view of an embodiment of a battery device of the present disclosure;

FIG. 2 is a perspective exploded view of the embodiment;

FIG. 3 is a perspective exploded view of a battery connection module of the embodiment;

FIG. 4 is a perspective exploded view of a plurality of busbars embedded in a cover plate of the battery connection module of the embodiment in which the plurality of busbars are separated;

FIG. 5 is a perspective exploded view of the battery connection module of the embodiment;

FIG. 6 is a view similar to FIG. 5 and in which the plurality of busbars and the cover plate are separated;

FIG. 7 is a top view of the embodiment;

FIG. 8 is a cross sectional view taken along a line VIII-VIII of FIG. 7;

FIG. 9 is a partial enlarged view of FIG. 8; and

FIG. 10 is a cross sectional view taken along a line X-X of FIG. 7.

### DETAILED DESCRIPTION OF THE PREFERRED EMBODIMENTS

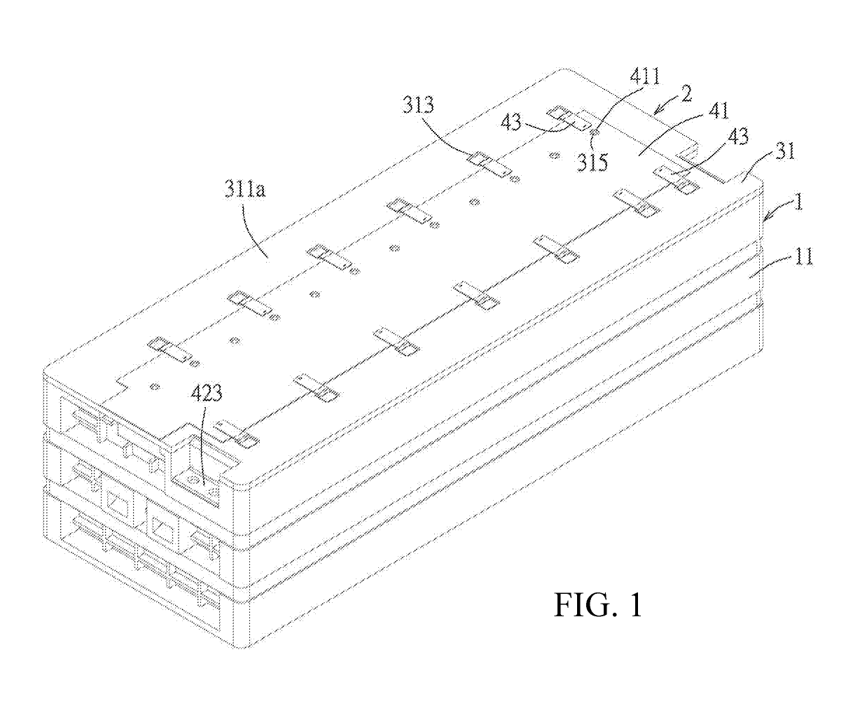

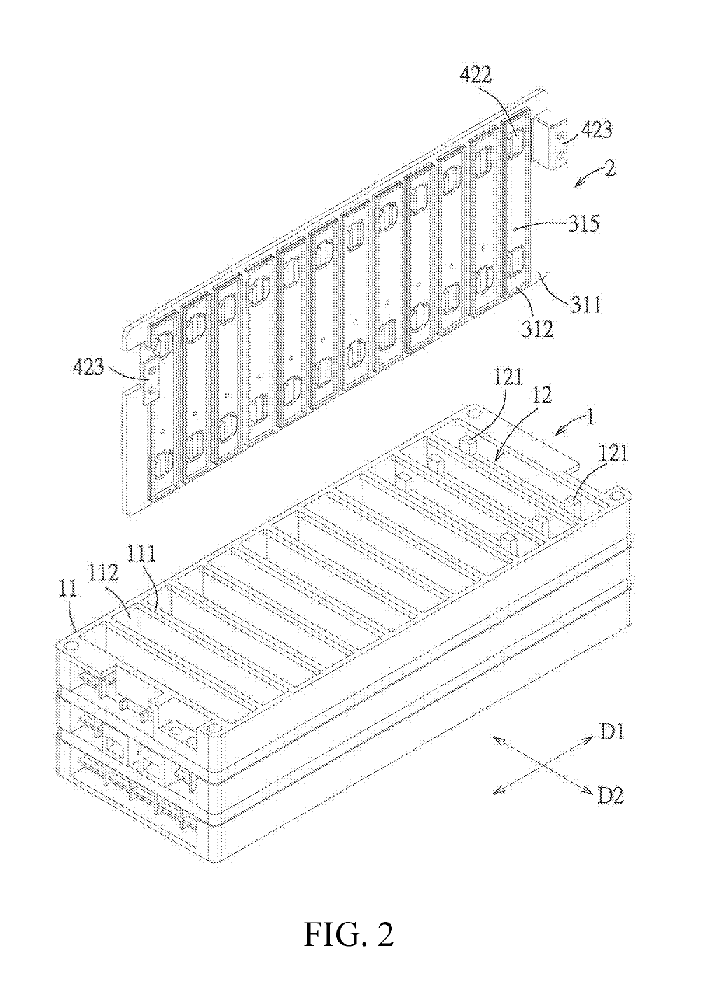

Referring to FIG. 1 and FIG. 2, an embodiment of a battery device of the present disclosure comprises a battery box 1 and a battery connection module 2. The battery box 1 has a box body 11 and a plurality of battery cells 12. The box body 11 has a plurality of spacing walls 111 which are arranged along a first direction D1 and spaced apart from each other to define a plurality of chambers 112, and the plurality of battery cells 12 are respectively provided to the plurality of chambers 112. Each battery cell 12 comprises a battery liquid (not shown, generally is an electrolyte) and electrodes 121 (generally are a positive electrode and a negative electrode).

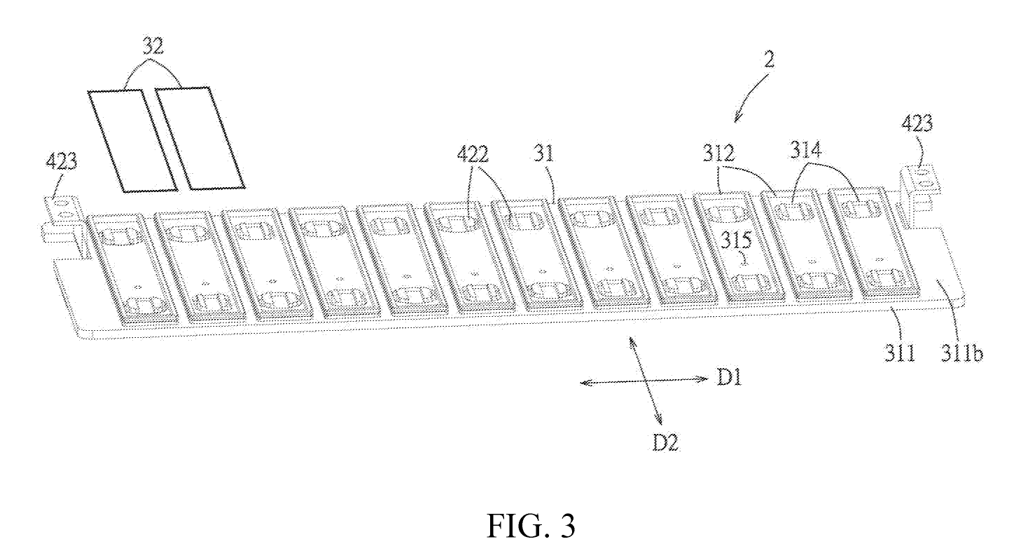

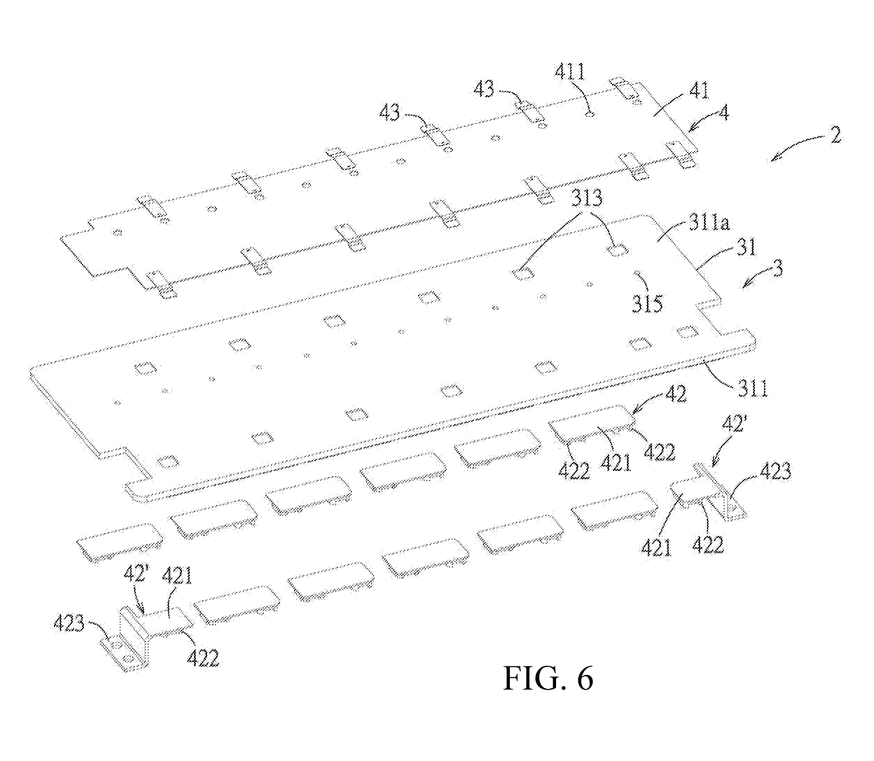

Referring to FIG. 2 to FIG. 6, the battery connection module 2 comprises a covering unit 3 and a circuit unit 4. The covering unit 3 is covered on a top of the box body 11, and comprises a cover plate 31 and a plurality of sealing members 32. The cover plate 31 has a plate body 311 extending along the first direction D1 and a plurality of plugging bodies 312 arranged along the first direction D1. The plate body 311 has an upper surface 311a and a lower surface 311b opposite to the upper surface 311a, the plurality of plugging bodies 312 integrally protrude from the lower surface 311b of the plate body 311, and each plugging body 312 extends along a second direction D2 perpendicular to the first direction D1 and exhibits as an elongated shape. The plurality of sealing members 32 are respectively provided to peripheries of the plurality of plugging bodies 312. In the embodiment, each sealing member 32 is provided in form of gasket and is sheathed on the periphery of the plugging body 312. The sealing members 32 each are made from a material which can be compressively elastically deformed, such as fluororubber or similar rubber material.

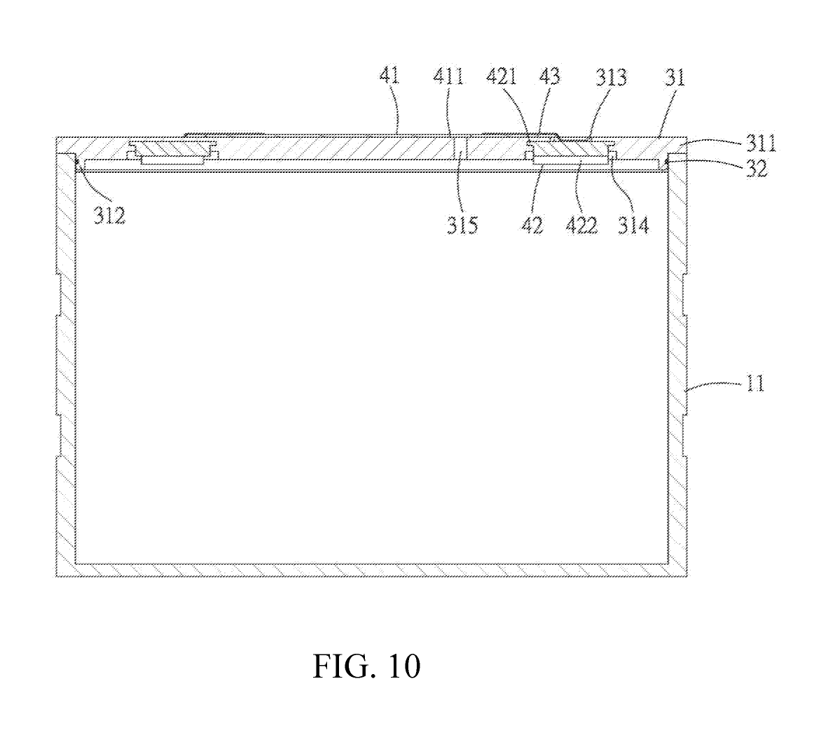

The circuit unit 4 comprises a circuit board 41 provided to the upper surface 311a of the plate body 311, a plurality of busbars 42 embedded in the cover plate 31 and a plurality of conductive connecting tabs 43 respectively corresponding to the plurality of busbars 42 to connect the plurality of busbars 42 to the circuit board 41. Each busbar 42 has a main body portion 421 and at least two electrode connecting portions 422. The plurality of busbars 42 are embedded in the plate body 311 as two rows spaced apart from each other, and each row is arranged along the first direction D1, positions of the electrode connecting portions 422 of each row respectively correspond to the plurality of plugging bodies 312, so that a position of each plugging body 312 covers two electrode connecting portions 422 which are positioned in the second direction D2 and respectively belong to the two rows of the busbars 42. The cover plate 31 further has a plurality of first openings 313 and a plurality of second openings 314, the plurality of first openings 313 are formed on the upper surface 311a of the plate body 311 and respectively correspond to the main body portion 421 of the plurality of busbars 42 to expose a portion of each main body portion 421, the plurality of second openings 314 are respectively formed on the plurality of plugging bodies 312 and respectively correspond to the electrode connecting portions 422 of the plurality of busbars 42 in position to expose each electrode connecting portion 422. Also in combination with referring to FIG. 10, each conductive connecting tab 43 connects with the corresponding main body portion 421 via the first opening 313 to connect the circuit board 41 to the main body portion 421.

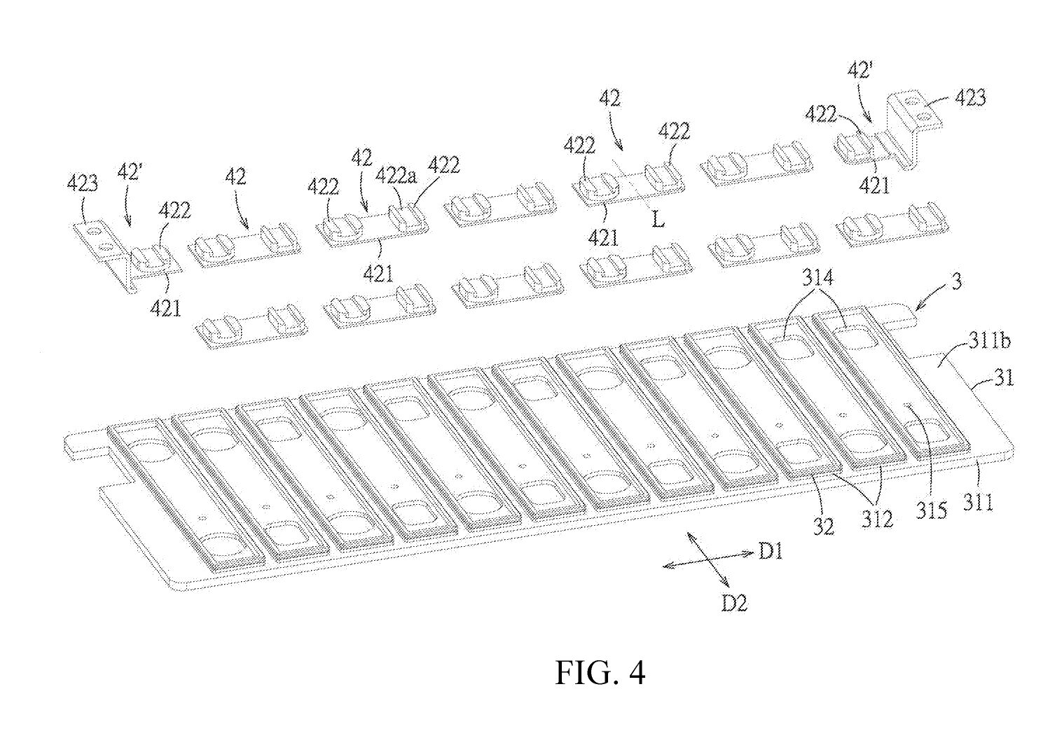

In the embodiment, each busbar 42 has two electrode connecting portions 422, and positions of the busbars 42 of the two rows are staggered in the second direction D2, so that two positions of the two electrode connecting portions 422 of each busbar 42 of one row, respectively, correspond to two positions of two adjacent electrode connecting portions 422 of two adjacent busbars 42 of the other row in the second direction D2, so as to make the plurality of battery cells 12 connected in series. In a varied embodiment, each busbar 42 may further has more than two electrode connecting portions 422, so as to make some battery cells 12 connected in parallel, and some battery cell 12 connected in series. In the embodiment, two ends of the plurality of busbars 42 arranged in rows each are provided with one busbar 42′ only having one electrode connecting portion 422, and each busbar 42′ further has an outside connecting portion 423 extending from the main body portion 421, so as to connect with an outside conductive wire (not shown). In the embodiment, each busbar 42 is made from the same material, such as a copper based metal, an aluminum base metal. However, in a varied embodiment, the electrode connecting portions 422 of the busbar 42 may be made from different materials, for example as shown in FIG. 4, two sides of a busbar 42 relative to an imaginary line L may be respectively made from an aluminum base metal and a copper based metal. Moreover, in the embodiment, each electrode connecting portion 422 of each busbar 42 protrudes into the corresponding second opening 314 from the main body portion 421 and exhibits as a protruding block. Each electrode connecting portion 422 has a recessed groove 422a to accommodate the corresponding electrode 121. In other embodiments, a structure and shape of the electrode connecting portion 422 may be changed to match with a structure and shape of the electrode 121. The busbars 42, 42′ are embedded in the cover plate 31 together when formed on the cover plate 31 in form of insert molding, therefore the plurality of first openings 313 of the cover plate 31 are not communicated with the plurality of second openings 314.

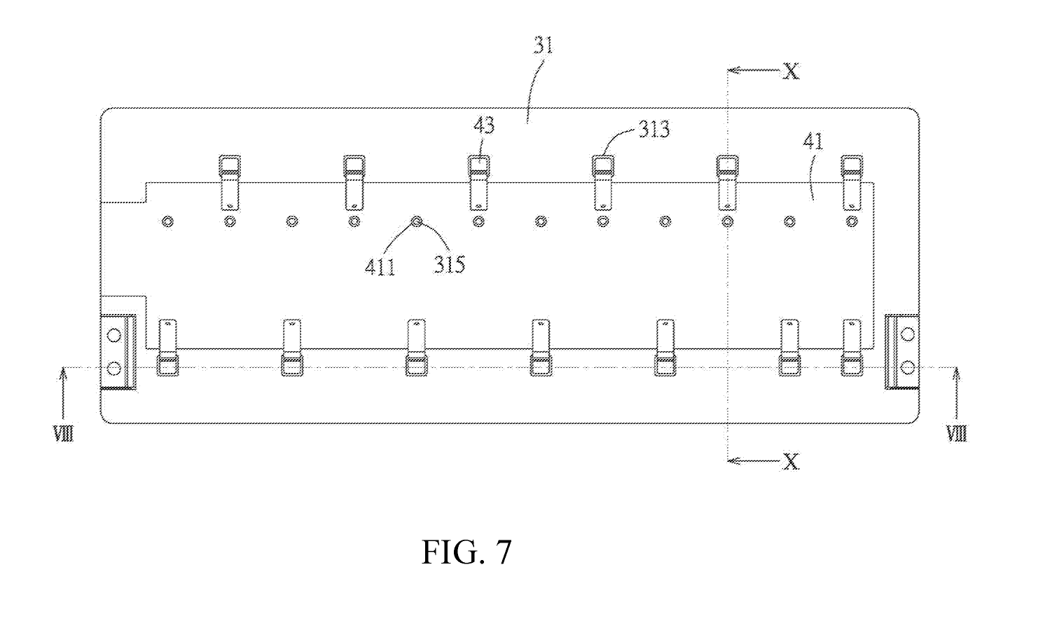

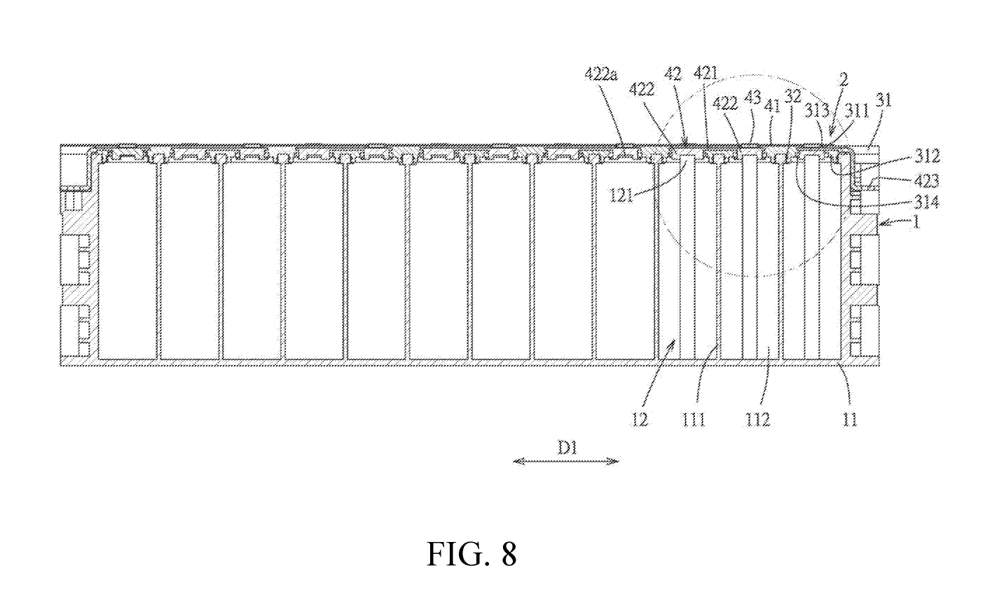

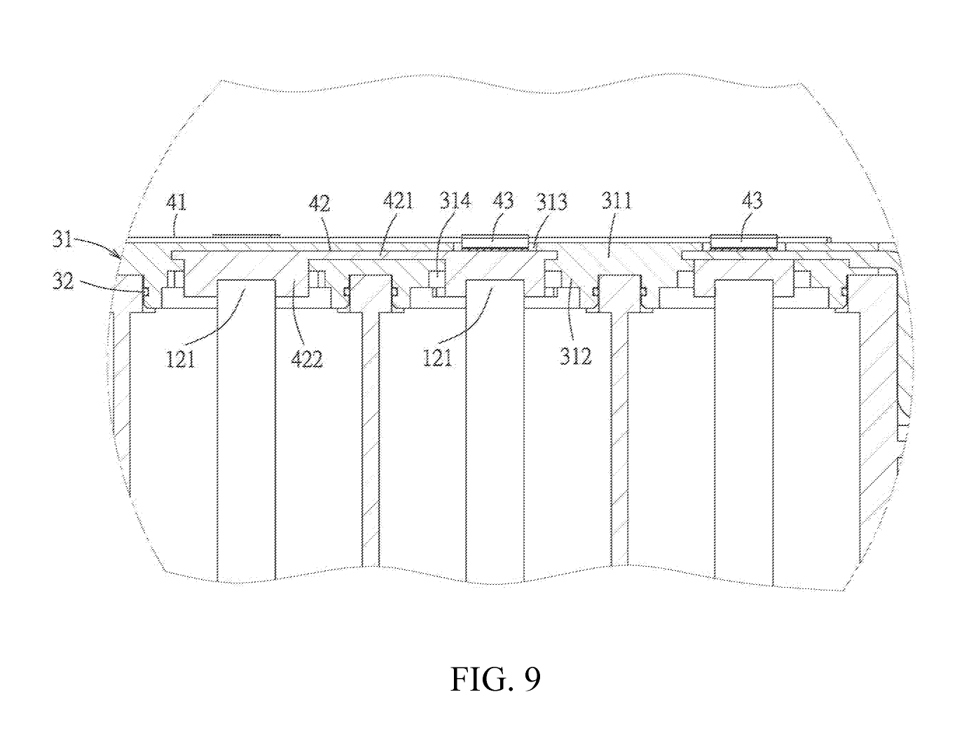

Referring to FIG. 7 to FIG. 10, the covering unit 3 is covered on the top of the box body 11, and the plurality of plugging bodies 312 are respectively plugged in the plurality of chambers 112, the plurality of sealing members 32 are respectively provided to between the plurality of plugging bodies 312 and the box body 11 to liquid-tight seal a gap between each plugging body 312 and the box body 11. The plurality of electrode connecting portions 422 respectively connect the electrodes 121 in the different chambers 112, so as to make the electrodes 121 in the plurality of chambers 112 connected in series. By that the plurality of busbars 42 are embedded in the cover plate 31, the plurality of first openings 313 are not communicated with the plurality of second openings 314, and the plurality of sealing members 32 each can liquid-tight seal a gap between the plugging body 312 and the box body 11, each chamber 112 can be well sealed to prevent leakage of the battery liquid.

In the embodiment, one end of each conductive connecting tab 43 is welded to the circuit board 41 and the other end is welded to the main body portion 421 of the busbar 42 via the first opening 313. Each conductive connecting tab 43 can be such as nickel based metal tab, and one end is welded to the circuit board 41 by reflow surface mounting technique (reflow SMT), then the other end is welded to the main body portion 421 of the corresponding busbar 42 by laser welding. Moreover, in the embodiment, the circuit board 41 is a flexible circuit board, so a thickness of the circuit board 41 can be thinner, and the circuit board 41 may be also additionally provided with various components, such as an electronic element, a sensor, a fuse, a connector and the like. However, in a varied embodiment, the circuit board 41 may be a printed circuit board, so which is not limited to the embodiment.

In the embodiment, the cover plate 31 and the box body 11 each are made from an insulating material, such as plastic material, preferably for example polyester material. The lower surface 311b of the plate body 311 is sealed and engaged to a top surface of the box body 11 by hot melting, such as ultrasonic welding, friction welding, heat board welding and laser welding and the like. By that the plate body 311 is sealed and engaged to the box body 11, the sealing effect of the battery liquid in the chamber 112 can be further enhanced. In a varied embodiment, the cover plate 31 also can be locked to the box body 11 by such as screws, which is not limited to the present embodiment.

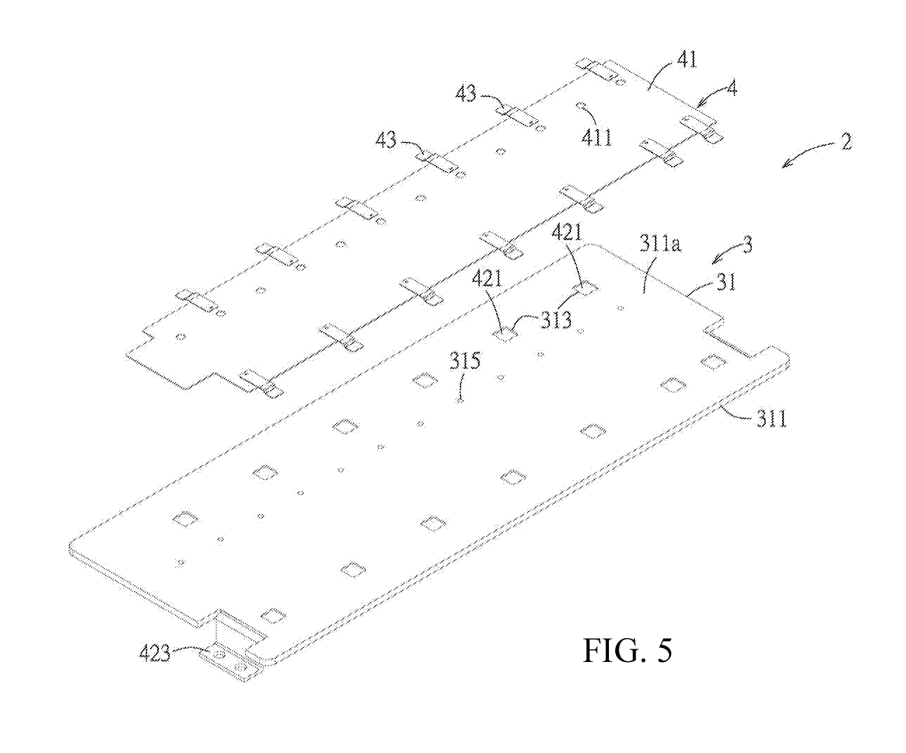

Again referring to FIG. 1, FIG. 2, FIG. 5 and FIG. 10, the cover plate 31 further has a plurality of liquid injecting holes 315 respectively passing through the plurality of plugging bodies 312 and the plate body 311 to be respectively communicated with the plurality of chambers 112, and the circuit board 41 has a plurality of through holes 411 respectively corresponding to the plurality of liquid injecting holes 315, so as to respectively expose the plurality of liquid injecting holes 315. The battery liquid is injected by the liquid injecting hole 315 and the through hole 411 which are communicated with each chamber 112, after the battery liquid is injected, the liquid injecting hole 315 are sealed by a plug (shown) or other means.

The battery connection module 2 may be assembled in advance, and then assembled with battery box 1. When the battery connection module 2 is assembled with the battery box 1, as long as the battery connection module 2 covers the corresponding battery box 1, then make cover plate 31 engaged and fixed to the box body 11 by hot melting. After the battery connection module 2 and the battery box 1 are assembled, the battery liquid is injected via the liquid injecting hole 315, finally the liquid injecting hole 315 are sealed. Therefore, an assembling process of the battery connection module 2 and the battery box 1 may be simple and easily operated.

In conclusion, the battery connection module 2 can be assembled as a module in advance, the assembling process of the battery connection module 2 and the battery box 1 is simpler, more convenient and easily operated, and can be indeed seal the battery liquid, and can make the plurality of electrodes 121 in the battery box 1 to electrically connected.

However, the foregoing description is made only for the embodiments of the present disclosure, and it is not intended to limit the scope of implementing the present disclosure, any simple equivalent variations and modifications in accordance with the scope of the present disclosure and the contents of the present specification belong to the scope of the claims of the present disclosure.

What is claimed is:

1. A battery connection module, comprising:
a covering unit comprising a cover plate and a plurality of sealing members, the cover plate having a plate body extending along a first direction and a plurality of plugging bodies arranged along the first direction, the plate body having an upper surface and a lower surface opposite to the upper surface, the plurality of plugging bodies integrally protruding from the lower surface of the plate body, and each plugging body extending along a second direction perpendicular to the first direction and exhibiting as an elongated shape, the plurality of sealing members being respectively provided to peripheries of the plurality of plugging bodies;
a circuit unit comprising a circuit board provided to the upper surface of the plate body, a plurality of busbars embedded in the cover plate and a plurality of conductive connecting tabs respectively corresponding to the plurality of busbars to connect the plurality of busbars to the circuit board, each busbar having a main body portion and at least two electrode connecting portions, the plurality of busbars being embedded in the plate body as two rows spaced apart from each other, and each row being arranged along the first direction, positions of the electrode connecting portions of each row respectively corresponding to the plurality of plugging bodies, so that a position of each plugging body covering two electrode connecting portions which are positioned in the second direction and respectively belong to the two rows of the busbars;
the cover plate further having a plurality of first openings and a plurality of second openings, the plurality of first openings being formed on the upper surface of the plate body and respectively corresponding to the main body portions of the plurality of busbars to expose a portion of each main body portion, the plurality of second openings being respectively formed on the plurality of plugging bodies and respectively corresponding to the electrode connecting portions of the plurality of busbars in position to expose each electrode connecting portion, and the plurality of first openings being not communicated with the plurality of second openings;
each conductive connecting tab being connected with the main body portion via the first opening so as to connect the circuit board to the main body portion.

2. The battery connection module according to claim 1, wherein each sealing member is provided in form of gasket and is sheathed on the periphery of the plugging body.

3. The battery connection module according to claim 1, wherein the circuit board is a flexible circuit board.

4. The battery connection module according to claim 1, wherein each electrode connecting portion of each busbar protrudes from the main body portion to the second opening and exhibits as a protruding block.

5. The battery connection module according to claim 1, wherein one end of each conductive connecting tab is welded to the circuit board and the other end is welded to the main body portion of the busbar via the first opening.

6. The battery connection module according to claim 1, wherein the cover plate further has a plurality of liquid injecting holes respectively passing through the plurality of plugging bodies and the plate body.

7. A battery device, comprising:
a battery box having a box body and a plurality of battery cells, the box body having a plurality of spacing walls which are arranged along a first direction and spaced apart from each other to define a plurality of chambers, and the plurality of battery cells being respectively provided to the plurality of chambers, each battery cell comprising a battery liquid and electrodes; and
a battery connection module comprising:
a covering unit covered on a top of the box body and comprising a cover plate and a plurality of sealing members, the cover plate having a plate body extending along the first direction and a plurality of plugging bodies arranged along the first direction, the plate body having an upper surface and a lower surface opposite to the upper surface, the plurality of plugging bodies integrally protruding from the lower surface of the plate body to respectively plug in the plurality of chambers, and each plugging body extending along a second direction perpendicular to the first direction and exhibiting as an elongated shape, the plurality of sealing members being respectively provided to between the plurality of plugging bodies and the box body to liquid-tight seal a gap between each plugging body and the box body, and
a circuit unit comprising a circuit board provided to the upper surface of the plate body, a plurality of busbars embedded in the cover plate and a plurality of conductive connecting tabs respectively corresponding to the plurality of busbars to connect the plurality of busbars to the circuit board, each busbar having a main body portion and at least two electrode connecting portions, the plurality of busbars being embedded in the plate body as two rows spaced apart from each other, and each row being arranged along the first direction, positions of the electrode connecting portions of each row respectively corresponding to the plurality of plugging bodies, so that a position of each plugging body covering the two electrode connecting portions which are positioned in the second direction and respectively belong to the two rows of the busbar,
the cover plate further having a plurality of first openings and a plurality of second openings, the plurality of first openings being formed on the upper surface of the plate body and respectively corresponding to the main body portions of the plurality of busbars to expose a portion of each main body portion, the plurality of second openings being respectively formed on the plurality of plugging bodies and respectively corresponding to the electrode connecting portions of the plurality of busbars to expose each electrode connecting portion, so that the plurality of electrode connecting portions respectively connecting the electrodes in different chambers, so as to make the electrodes in the plurality of chambers connected in series, and the plurality of first openings being not communicated with the plurality of second openings,
each conductive connecting tab connecting with the main body portion via the first opening to connect the circuit board to the main body portion.

8. The battery device according to claim 7, wherein each sealing member is provided in form of gasket and is sheathed on a periphery of the plugging body.

9. The battery device according to claim 7, wherein the circuit board is a flexible circuit board.

10. The battery device according to claim 7, wherein each electrode connecting portion of each busbar protrudes into the second opening from the main body portion and exhibits as a protruding block.

11. The battery device according to claim 7, wherein one end of each conductive connecting tab is welded to the circuit board and the other end is welded to the main body portion of the busbar via the first opening.

12. The battery device according to claim 7, wherein the cover plate further has a plurality of liquid injecting holes respectively passing through the plurality of plugging bodies and the plate body to respectively communicate with the plurality of chambers.

13. The battery device according to claim 7, wherein the lower surface of the plate body is sealed and engaged to a top surface of the box body.

14. The battery device according to claim 13, wherein the lower surface of the plate body is sealed and engaged to the top surface of the box body by hot melting.
